(19) United States
(12) Patent Application Publication
(10) Pub. No.: US 2005/0260470 A1
(43) Pub. Date: Nov. 24, 2005

(54) Fuel cell and control method thereof

(75) Inventors: Shinji Nezu, Obu-shi (JP); Yosuke Oyabe, Tsushima-shi (JP); Naoki Ito, Aichi-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 10/629,550

(22) Filed: Jul. 30, 2003

(30) Foreign Application Priority Data
Jul. 30, 2002 (JP) 2002-221906

(51) Int. Cl. H01M 8/18; H01M 8/10; H01M 8/04

(52) U.S. Cl. 429/21; 429/30; 429/17; 429/22

(57) ABSTRACT

One embodiment of the present invention provides a fuel cell, which includes an electrolyte comprising at least one proton conductor; a fuel electrode provided on a first side of the electrolyte; an oxidant electrode provided on a second side of the electrolyte; at least one internal electrode provided in the electrolyte; and an electric voltage application means provided either between the internal electrode and the fuel electrode or between the internal electrode and the oxidant electrode. Other embodiments include methods of making and using and controlling the fuel cell.

This application is based on and claims priority to Japanese Patent Appln. No. 2002-221906 filed on Jul. 30, 2002, the entire contents of which are incorporated herein by reference.

### FIELD OF THE INVENTION

The present invention relates to a fuel cell. More particularly, the present invention pertains to a fuel cell including a proton conducting electrolyte and a control method of the fuel cell.

### BACKGROUND OF THE INVENTION

Fuel cells are expected to be widely used as a power source for vehicles (EV/HEV), in household use, and the like. Various types of fuel cells have been studied and developed in accordance with the type of electrolyte. The fuel cell including a proton conductor for the electrolyte is represented by a phosphoric-acid fuel cell (PAFC) and high polymer solid electrolyte fuel cell. In particular, a high polymer solid electrolyte fuel cell is applicable to power generation for electric vehicles and for household use because the high polymer solid electrolyte fuel cell is relatively small and is suitable for low temperature operation.

With the fuel cell including the proton conductor as the electrolyte, fuels such as hydrogen and methanol supplied to an anode serving as a fuel electrode are oxidized to generate the electron and proton. The proton reaches a cathode serving as an oxidant electrode via the proton conductor serving as the electrolyte to react with the oxygen supplied to the cathode and the electron supplied from the anode via an external load eventually to generate water. In this case, the electric voltage corresponding to the free energy change when generating the water by the reaction between the fuel and the oxygen is generated as the maximum electric voltage between the anode and the cathode. This electric voltage is obtained as the electric energy.

Notwithstanding, the operation explained above is an idealistic operation of the fuel cell, and various phenomena reduce the performance of the fuel cell and deteriorate material(s) within the actual fuel cell. One reason for the foregoing drawbacks is the gas permeability of an ion exchange membrane performing as the proton conductor. Ideally, only the proton permeates the proton conductor, and the proton conductor completely blocks the oxygen gas serving as the oxidant and the hydrogen gas serving as the fuel. However, with conventional ion exchange membranes, significant amounts of gas permeation through the proton conductor are observed.

With gas permeation, the gases are mixed to reduce the electric voltage of the cell. Further, with the reaction of the permeated gases, the ion exchange membrane is burned resulting in an undesirable hole in the membrane, and in the worst case, the cell may become immobile or inoperative.

Regarding the permeation of the gas, the hydrogen may permeate the membrane to reach the cathode side, or the oxygen may reach the anode side via the membrane.

Japanese Patent Laid-Open Publication No. 6-103992 describes a high polymer solid electrolyte fuel cell including a catalyst layer in an ion exchange membrane electrically insulated from the anode and cathode in order to prevent the decline of the cell electric voltage by the gas permeating via the ion exchange membrane and to make it possible to apply the hydrocarbon ion exchange membrane which is reasonable price as the ion exchange membrane.

With the fuel cell described in Japanese Patent Laid-Open Publication No. 6-103992, the hydrogen permeating from the anode to the opposite electrode and the oxygen permeating from the cathode are consumed by reacting with each other in a catalyst layer positioned perpendicularly to the direction of the permeation of the gas in the ion exchange membrane to generate the water. Thus, the gas permeation is decreased to restrain the decline of the electric voltage of the cell.

The catalyst layer positioned in the ion exchange membrane according to Japanese Patent Laid-Open Publication No. 6-103992 is described as protecting the ion exchange membrane by exchanging a radical generated by the cathode reaction to an inactive material to make it possible to use the carbon hydrogen ion exchange membrane, which is vulnerable against radical.

Notwithstanding, although both hydrogen and oxygen are completely consumed in the catalyst layer in the ion exchange membrane only when stoichiometric ratio of the oxygen permeated from the cathode and the hydrogen permeated from the anode is one to two (i.e., oxygen: hydrogen=1:2) with the foregoing method, the gas including a permeation amount with other stoichiometric ratio of the oxygen or the hydrogen relative to each other is not consumed to reach the opposite electrode. Further, when the hydrogen and oxygen react on a platinum catalyst, the radical is generated when the potential of the platinum catalyst is lower than a predetermined potential. Thus, when the platinum catalyst layer is positioned in the ion exchange membrane, the radical is generated depending on the potential of the platinum catalyst other than generating the water by the reaction of oxygen and hydrogen to deteriorate the membrane.

A need thus exists for a high polymer solid electrolyte fuel cell which prevents the chemical deterioration of materials such as ion exchange membrane by the generation of the radical, the damage of the cell due to burning, and the output decline of the fuel cell induced by the permeation of hydrogen or oxygen through the ion exchange membrane.

### SUMMARY OF THE INVENTION

In light of the foregoing, one embodiment of the present invention provides a fuel cell, which includes:
an electrolyte including at least one proton conductor;
a fuel electrode provided on a first side of the electrolyte;
an oxidant electrode provided on a second side of the electrolyte;
at least one internal electrode provided in the electrolyte; and
an electric voltage application means provided either between the internal electrode and the fuel electrode or between the internal electrode and the oxidant electrode.

Another embodiment of the present invention provides a method for generating electricity, which includes contacting at least one fuel and at least one oxidant with the above fuel cell.

Another embodiment of the present invention provides a method for making the above fuel cell, which includes electrically connecting the electric voltage application means between the internal electrode and the fuel electrode or between the internal electrode and the oxidant electrode.

Another embodiment of the present invention provides a method for controlling a fuel cell,
wherein the fuel cell includes:
an electrolyte including a proton conductor;
a fuel electrode provided on a first side of the electrolyte;
an oxidant electrode provided on a second side of the electrolyte;
at least one internal electrode provided in the electrolyte;
wherein the method includes:
controlling a movement of the fuel or the oxidant in the electrolyte by applying an electric voltage either between the internal electrode and the fuel electrode or between the internal electrode and the oxidant electrode.

### BRIEF DESCRIPTION OF THE FIGURES

The foregoing and additional features and characteristics of the present invention will become more apparent from the following detailed description considered with reference to the accompanying drawing figures in which like reference numerals designate like elements.

FIG. 1 shows a cross section of a main portion of one embodiment of the fuel cell of the present invention.

FIG. 2 shows a cross section of a main portion of another embodiment of the fuel cell of the present invention.

### DETAILED DESCRIPTION OF THE INVENTION

Various other objects, features and attendant advantages of the present invention will be more fully appreciated as the same becomes better understood from the following detailed description of the preferred embodiments of the invention.

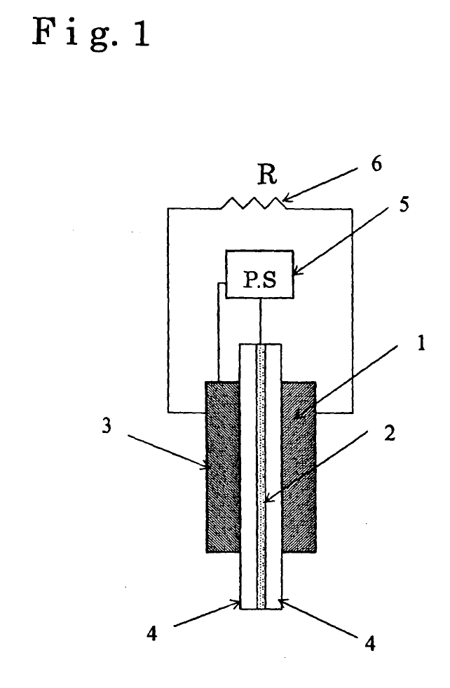

In order to control the potential of an internal electrode layer, a circuit for providing an electric current between the internal electrode layer and a fuel electrode is formed as shown in FIG. 1. By controlling the electrode potential of the internal electrode layer, the permeation of the fuel and the oxidant to the opposite electrode is reduced.

The resting potential of the internal electrode layer is determined in accordance with the concentration of the fuel and the oxidant reaching the internal electrode layer by permeating the proton conductor. With the fuel cell including hydrogen as the fuel and oxygen as the oxidant, the resting potential of the internal electrode layer shows a negative close to the hydrogen electrode potential when the permeation of the hydrogen is greater than the permeation of the oxygen. To the contrary, the resting potential shows a positive close to the oxygen electrode potential when the permeation of the oxygen is greater than the permeation of the hydrogen. The degree of hydrogen and oxygen permeation is determined by the permeability of the proton conductor relative to the hydrogen and oxygen and the gas supply pressure.

When the resting potential is the negative and is close to the hydrogen electrode potential, the permeated oxygen is consumed by the reaction with the excessive hydrogen in the internal electrode layer. The radical is generated at the negative potential closer to the hydrogen electrode potential. Further, the excessive hydrogen permeates the proton conductor to the oxygen electrode.

When the oxidizing electric current is provided so that the potential of the internal electrode layer 2 is positive in a circuit shown in FIG. 1, the generation of the radical is reduced, and the excess hydrogen is oxidized in the internal electrode layer 2, and thus the permeation of the hydrogen to the oxygen electrode (an oxidant electrode 1) is reduced.

When the resting potential of the internal electrode layer 2 is the positive closer to the oxygen electrode potential, the hydrogen permeating the internal electrode layer 2 is consumed reacting with the excessive oxygen, and the generation of the radical is restrained. The excessive oxygen permeates the proton conductor to the hydrogen electrode (fuel-electrode 3).

When the potential of the internal electrode layer 2 is controlled by a potentiostat 5 electrically connected between the internal electrode layer 2 and the fuel electrode 3 such that the potential of the internal electrode layer 2 is negative (but preferably not to such a degree as to generate radicals) and the reduction current is provided, the excess oxygen is reduced to water on the internal electrode layer 2 to minimize the oxygen reaching the fuel electrode 3 side.

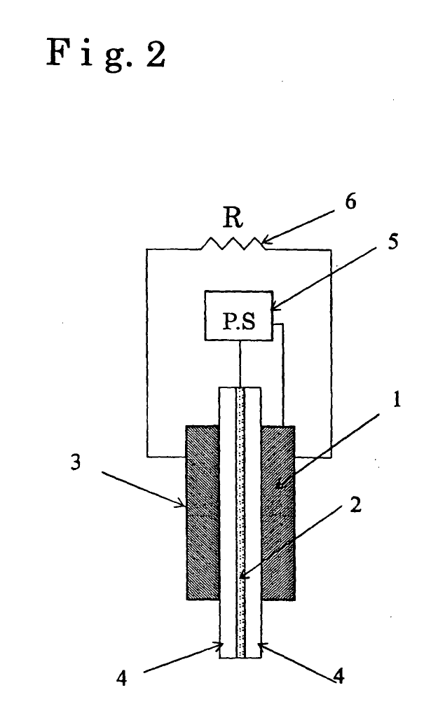

The control in the case of FIG. 2, like that of FIG. 1, is achieved by constructing a circuit including a potentiostat 5 for providing the electric current between the internal electrode layer 2 and the oxidant electrode 1 and by controlling the potential of the internal electrode layer 2.

Further, plural internal electrode layers may be positioned in the proton conductor to control the electrode potential thereof. The internal electrode layer may be constructed with particles of one or more supported catalysts and sandwiched by proton conductors. The internal electrode layer per se should preferably include the proton conduction so that the internal electrode layer does not insulate the ion conduction of the proton conductor. In order to avoid the insulation, the internal electrode layer may be constructed by combining the catalyst particles with the proton conductor.

One preferred embodiment of the invention provides a fuel cell which includes an electrolyte including a proton conductor, a fuel electrode provided on a first side of the electrolyte, an oxidant electrode provided on a second side of the electrolyte, at least one internal electrode provided in the electrolyte, and an electric voltage application means provided either between the internal electrode and the fuel electrode or between the internal electrode and the oxidant electrode.

According to another preferred embodiment of the present invention, a control method of a fuel cell includes an electrolyte including a proton conductor, a fuel electrode provided on a first side of the electrolyte, an oxidant electrode provided on a second side of the electrolyte, and at least one internal electrode provided in the electrolyte. A movement of the fuel or the oxidant in the electrolyte is controlled by applying an electric voltage either between the internal electrode and the fuel electrode or between the internal electrode and the oxidant electrode.

### EXAMPLES

Having generally described this invention, a further understanding can be obtained by reference to certain specific examples which are provided herein for purposes of illustration only and are not intended to be limiting unless otherwise specified.

After soaking a carbon paper having thickness of 180 μm (φ36.5 mm) in twenty percent PTFE dispersion solution and drying the carbon paper, the carbon paper is calcined at 400° C. for water repellent. A past of carbon black and ethylene glycol is formed as screen print on one surface of the carbon paper, then the carbon paper is air dried and thereafter dried in vacuum for five hours by 140° C. Thereafter, the carbon black layer is performed with the water repellent treatment with the same method with providing the water repellent to the carbon paper. Platinum catalyst paste mixed with platinum retaining carbon catalyst (e.g., platinum retaining amount 40 wt %), high polymer solid electrolyte membrane solution (NAFION solution: Trademark for Dupont), and isopropyl alcohol as dispersion solution is applied on the carbon black layer by thickness of 300 μm with applicator and dried in the vacuum for two hours by 80° C. to form the electrode with the catalyst layer.

Two high polymer solid electrolyte membranes of 35 μm produced by radiation graft polymerization of styrene in ETFE base film with the thickness of 25 μm and by performing sulfonation with chlorosulfuric acid are cut out in the same size (approximately φ60 mm) and dried. A predetermined application amount of the aforementioned platinum catalyst paste is sprayed on one surface of one of the membranes, and the membrane is air dried and then dried in the vacuum for two hours by 80° C.

A membrane with internal platinum catalyst layer/electrode combined body (i.e., hereinafter referred as MEA with platinum catalyst layer) is produced by soaking both membranes in the water, by sandwiching the platinum mesh with platinum lead wire (150 mesh, wire diameter 20 μm) between two high polymer solid electrolyte membranes positioning the surface applied with the platinum catalyst paste inside, by positioning the electrode with catalyst layer to the outside of the membranes on the both sides, and by unitary conjugating with hot press (e.g., 160° C., 80 kg/cm²).

The fuel cell is constructed by fixing the MEA with platinum catalyst layer sandwiched by small collectors for the evaluation having gas conduit. An experimental circuit as shown in FIG. 1 connecting the potentiostat between the anode (i.e., fuel electrode) and the membrane internal platinum catalyst electrode layer is constructed.

The hydrogen on the anode, and the oxygen on the cathode, are moisturized through a gas bubbler (heat retention at approximately 30° C.) for each gas and the gas exchange in gas pipes and in a fuel cell body is performed by flowing the pure water with 100 ml per minute for 20 minutes. Thereafter, gas valves of each gas inlet and gas outlet of the fuel cell are closed, approximately one liter (i.e., volume including the internal volume of the fuel cell and the attached gas pipes) of each gas is injected under 2 atmospheres, and the cell temperature is retained at 80° C. The potential of the membrane internal platinum catalyst layer is controlled to be +0.8V by the potentiostat with reference to the anode and the gas injection (no load) state is maintained for fifteen hours. The comparison experiment for gas injection is performed using different MEA (membrane with internal electrode) with the same specification under the same condition except a condition not performing the potential control of the internal electrode.

Comparing the change of the cell electric voltage during the gas injection experiment, the cell electric voltage is declined as the time goes by under the condition that the potential control of the membrane internal platinum catalyst layer is not performed. To the contrary, a constant electric voltage approximately close to the initial electric voltage is maintained until the end of the experiment in case the potential control is not performed.

After gas injection experiment for fifteen hours, the MEA is removed from the test cell by leaking the gas, the electrode and the catalyst layer attached to the high polymer electrolyte membrane is removed to make a single membrane, soaked in 1N KOH in order to remove the influence by the water included in the membrane, and dried to provide FT-IR analysis.

According to the experiment without performing the potential control, the height of infrared absorption peak (wave number 2980 cm⁻¹) arising from C-H stretching vibration of ETFE which is a base film of the membrane does not change, and thus it is judged that the base film is not deteriorated. However, the heights of the peak (wave number 2930 cm⁻¹) regarding the C-H stretching vibration of benzene ring of styrene (graft chain) and the peak (wave number 1410 cm⁻¹) regarding C-C stretching vibration of benzene ring are apparently declined, and the styrene grafted by the oxidation decomposition of the membrane is missing.

On the other hand, with the present invention performing the potential control, the height of the peak does not change compared to the height before the experiment, and the deterioration of the membrane is not observed.

The foregoing result is obtained by the effect to restrain the deterioration of the membrane and the decline of the cell electric voltage by the mixture of the gases and to restrain the permeation of the hydrogen to the oxidant electrode side by protonating the hydrogen gas about to permeating to the opposite electrode side by being oxidized on the membrane internal electrode layer controlled with the potential by controlling the potential of the membrane internal electrode layer.

A second embodiment of the present invention will be explained as follows. A catalyst electrode produced by the method of the first embodiment, GORE-SELECT membrane (Japan Gore-Tex, thickness 30 μm, diameter approximately 6 cm), and GORE-SELECT membrane applied with catalyst paste on one side of the same size are prepared. An MEA including platinum catalyst layer produced by sandwiching platinum foil of 20 μm between two GORE-SELECT membranes positioning surfaces applied with the platinum catalyst inside and soaked with the water and a normal MEA (without internal electrode layer, one GORE-SELECT membrane) are produced.

Similar to the first embodiment, the MEAs are assembled to the small fuel cell for the evaluation to construct the potential addition circuit to the internal catalyst electrode as shown in FIG. 1. An electrolytic current 3A is energized to a water electrolytic cell to generate the hydrogen gas and the oxygen gas and introduce the moisturized gas via the gas bubbler (e.g., the temperature is retained at 50° C. on the hydrogen side, 40° C. of the oxygen side) including the pure water to the fuel cell which temperature is retained at 75° C. Under the foregoing condition, a cycle operation test repeating load operation (e.g., load electric current density 0.1A/cm²) for one minute and non-load operation (i.e., open circuit electric voltage operation) for three minutes is performed. The cycle operation test of the normal MEA carried out under the same conditions except that the separate normal MEA is not applied with the potential application operation is performed to compare the behavior of the cells.

Accordingly, the MEA with the platinum catalyst layer maintains a stable electric voltage (open circuit electric voltage) of approximately 1V approximate to the theoretical electric voltage 200 hours after starting the operation. On the other hand, with the normal MEA, the output electric voltage (open circuit electric voltage) likely to decline after approximately 100 hours, the fluctuation is increased, and the operation is stopped. Analyzing the cause of the stop of the operation by removing the MEA from the cell, the membrane is deteriorated to have a hole thereon.

The foregoing result is obtained as the difference of the duration of MEAs by the effect for restraining the deterioration of the membrane and the stabilization of the cell electric voltage (open circuit electric voltage) by restraining the permeation of the hydrogen to the oxidant electrodes (oxygen electrode side) in case of both load operation mode and the open circuit electric voltage mode by performing the potential control of the internal electrode layer electrode of the MEA with platinum catalyst layer.

Obviously, numerous modifications and variations of the present invention are possible in light of the teachings herein. It is therefore to be understood that within the scope of the appended claims, the invention may be practiced otherwise than as specifically described herein.

1. A fuel cell, comprising:
an electrolyte comprising at least one proton conductor;
a fuel electrode provided on a first side of the electrolyte;
an oxidant electrode provided on a second side of the electrolyte;
at least one internal electrode provided in the electrolyte; and
an electric voltage application means provided either between the internal electrode and the fuel electrode or between the internal electrode and the oxidant electrode.

2. The fuel cell according to claim 1, wherein the internal electrode is a single layer.

3. The fuel cell according to claim 1, wherein the internal electrode comprises a plurality of layers.

4. The fuel cell according to claim 1, wherein the electrolyte comprises at least one ion exchange membrane.

5. The fuel cell according to claim 1, further comprising at least one fuel selected from the group consisting of hydrogen, methanol, and a mixture thereof.

6. The fuel cell according to claim 1, wherein the electric voltage application means comprises at least one potentiostat electrically connected between the internal electrode and the fuel electrode.

7. The fuel cell according to claim 1, wherein the electric voltage application means comprises at least one potentiostat electrically connected between the internal electrode and the oxidant electrode,

8. The fuel cell according to claim 1, wherein the potential of the internal electrode layer is controlled by a potentiostat electrically connected between the internal electrode and the fuel electrode.

9. The fuel cell according to claim 1, wherein the potential of the internal electrode layer is controlled by a potentiostat electrically connected between the internal electrode and the oxidant electrode.

10. The fuel cell according to claim 1, wherein the internal electrode comprises particles of one or more catalysts on one or more supports and sandwiched by a plurality of proton conductors.

11. The fuel cell according to claim 1, wherein the internal electrode comprises particles of one or more catalysts on one or more supports and sandwiched by a plurality of proton conductors, and wherein said catalyst comprises platinum.

12. The fuel cell according to claim 1, wherein the electrolyte comprises a high polymer solid electrolyte.

13. The fuel cell according to claim 1, further comprising one or more collectors.

14. The fuel cell according to claim 1, further comprising a conduit means for transporting one or more fluids selected from the group consisting of fuel, hydrogen, methanol, oxygen, air, water, and a mixture thereof to or from the fuel cell.

15. A method for generating electricity, comprising contacting at least one fuel and at least one oxidant with the fuel cell as claimed in claim 1.

16. A method for making the fuel cell as claimed in claim 1, comprising electrically connecting the electric voltage application means between the internal electrode and the fuel electrode or between the internal electrode and the oxidant electrode.

17. The method according to claim 16, wherein the electric voltage application means comprises at least one potentiostat electrically connected between the internal electrode and the fuel electrode or between the internal electrode and the oxidant electrode.

18. A method for controlling a fuel cell,
the fuel cell comprising:
an electrolyte comprising at least one proton conductor;
a fuel electrode provided on a first side of the electrolyte;
an oxidant electrode provided on a second side of the electrolyte;
at least one internal electrode provided in the electrolyte;
the method comprising:
controlling a movement of the fuel or the oxidant in the electrolyte by applying an electric voltage either between the internal electrode and the fuel electrode or between the internal electrode and the oxidant electrode.

19. The method according to claim 18, wherein the electric voltage is controlled by at least one potentiostat.
